(19) United States
(12) Patent Application Publication
(10) Pub. No.: US 2008/0178537 A1
(43) Pub. Date: Jul. 31, 2008

(54) Portable modular manufacturing system

(76) Inventors: John M. Spangler, Peoria, IL (US); Mark E. Dietz, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/700,109

(22) Filed: Jan. 31, 2007

(51) Int. Cl. E04H 1/00; B66F 3/24

(52) U.S. Cl. 52/36.1; 254/93 R

(57) ABSTRACT

A modular manufacturing station is provided. The modular manufacturing station has a plurality of beams forming a skeleton and being capable of extension and retraction. The modular manufacturing station also has at least one utility connection for receiving external utilities. Additionally, the modular manufacturing station has at least one piece of manufacturing equipment. Furthermore, the modular frame has a control system configured to regulate operation of the manufacturing equipment.

### TECHNICAL FIELD

The present disclosure is directed to a manufacturing system, and more particularly, to a modular manufacturing system having portable capabilities.

### BACKGROUND

A finished product is typically manufactured in steps, through the use of individual manufacturing stations having machines or system parts that are specifically constructed for a specialized purpose. These individual manufacturing stations are linked together to form a manufacturing chain, through which each product being produced is advanced. Such manufacturing chains are often large structures permanently situated inside a manufacturing facility.

Because of their large sizes and permanency, conventional manufacturing chains are usually inflexible and are only cost-effective for the production of one type of finished product. If a design or product falls out of favor with the market, the manufacturing chain must be modified to produce a new finished product or design. When this happens, those manufacturing stations originally designed to be permanent fixtures in the manufacturing chain must be modified, removed, or replaced, which can be an expensive and time-consuming process.

An additional constraint on finished products manufactured inside a permanent manufacturing facility is that the finished product must be shipped to the customer. That is, in order to be utilized by a customer, the finished product must be loaded onto a transportation vehicle such as, for example, a truck, boat or airplane. The finished product must then be unloaded from the transportation vehicle and installed at the location where the finished product will be utilized by the customer. A multitude of costs are associated with the transportation of the finished product such as, for example, fuel costs, labor costs, vehicle maintenance costs, and vehicle purchase costs. Such costs can contribute to the costs of production.

U.S. Pat. No. 6,916,375 issued to Molnar et al. (Molnar) on Jul. 12, 2005, discloses a mobile manufacturing facility capable of being located at a job site requiring a manufactured finished product. The system in the Molnar patent comprises a portable manufacturing facility housed inside a modified truck trailer. Manufacturing stations required to produce the finished product are installed in the truck trailer in a set configuration. In one configuration, the truck trailer contains two coating booths for applying an anti-slip coating material onto metal plates and metal grates. An exhaust scrubber for purging smoke or dust from exhaust created during the application process is located in the front of the trailer. Additionally, a motor generator and an air compressor for powering the coating booths are situated alongside the exhaust scrubber toward the front of the trailer. An application machine is situated inside each coating booth for applying the anti-slip coating to the metal plates and grates.

Although the manufacturing facility in Molnar is located on a truck trailer and can be moved to multiple jobsites, its portability may be limited by the truck trailer itself. Because the manufacturing facility is permanently situated inside the truck trailer, it can only be utilized at jobsites having an infrastructure capable of accommodating the truck trailer. Also, the jobsite needs to be adjacent to roads accessible by the truck trailer. For example, jobsites located within the interior of a building may be inaccessible to vehicles and cannot accommodate manufacturing facilities located within a truck trailer.

Additionally, the size and geometry of the manufacturing chain in Molnar is limited by the size and geometry of the truck trailer. The process utilized to produce finished products may require manufacturing chains having a shape and/or size that cannot be accommodated by a truck trailer. For example, a finished product may require multiple manufacturing stations such as infrared ovens, inspection stations, and wash stations situated in a formation that may be incompatible with the size and geometry of a truck trailer.

Furthermore, installing a manufacturing chain inside a truck trailer may limit the flexibility of the manufacturing system. In particular, because the truck trailer has a finite amount of space, the types of manufacturing stations that can be utilized may be limited. Certain finished products may require manufacturing stations that are too large to be installed in a truck trailer and therefore cannot be produced in a truck trailer manufacturing system. Moreover, the finished product may require a greater number of manufacturing stations than can be accommodated by a truck trailer. Additionally, because of the constricted confines of the truck trailer, it may be difficult to remove and/or add manufacturing stations to produce a new product or design, as required to meet demands of the market.

The disclosed manufacturing system is directed to overcoming one or more of the problems set forth above.

### SUMMARY OF THE INVENTION

In one aspect, the present disclosure is directed toward a modular manufacturing station. The modular manufacturing station includes a plurality of beams forming a skeleton and being capable of extension and retraction. The modular manufacturing station also includes at least one utility connection for receiving external utilities. Additionally, the modular manufacturing station includes at least one piece of manufacturing equipment. Furthermore, the modular frame includes a control system configured to regulate operation of the manufacturing equipment.

Consistent with a further aspect of the disclosure, a method is provided for deploying a manufacturing station. The method includes connecting the manufacturing station to a utilities source. Additionally, the method includes expanding the manufacturing station to a desired dimension. Furthermore, the method includes setting the manufacturing station to an operational state in which the manufacturing station performs a manufacturing task.

### BRIEF DESCRIPTION OF THE DRAWINGS

FIG. 1 is a diagrammatic illustration of a manufacturing chain according to an exemplary disclosed embodiment;

FIG. 2 is a diagrammatic representation of a modular frame utilized by the modules of the manufacturing chain according to an exemplary disclosed embodiment;

FIG. 3 is a schematic representation of a hydraulic control system of the frame according to an exemplary disclosed embodiment;

FIG. 4 is a schematic representation of an electric motor control system of the frame according to an exemplary disclosed embodiment;

FIG. 5 is a schematic representation of a module connecting device located on the frame according to an exemplary disclosed embodiment;

FIG. 6 is a pictorial illustration of a an electric infrared heater module in a contracted state according to an exemplary disclosed embodiment; and

FIG. 7 is a flow diagram depicting an exemplary disclosed method of expanding and utilizing the frame.

### DETAILED DESCRIPTION

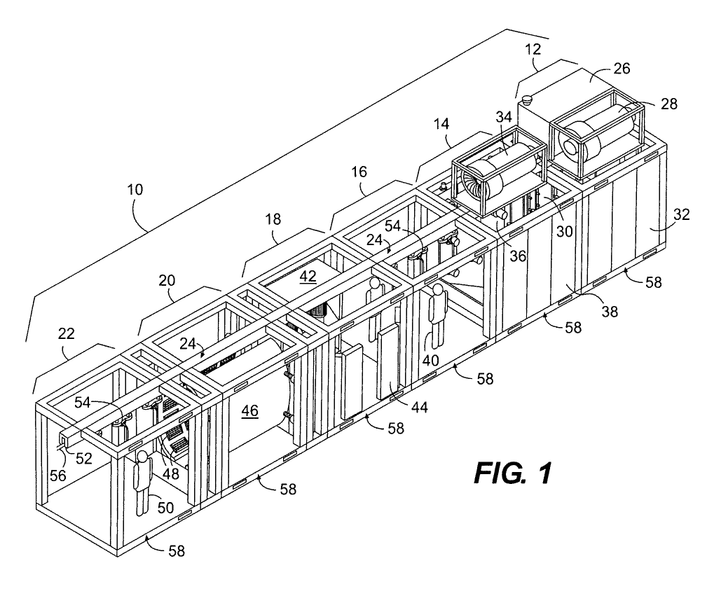

FIG. 1 provides a diagrammatic perspective of a manufacturing chain 10 according to an exemplary embodiment. Manufacturing chain 10 may be used to perform a manufacturing process such as, for example, powder coating an article. Manufacturing chain 10 may include several modular manufacturing units for performing the manufacturing task. Such modular manufacturing units may include, for example, a washer module 12, a blow off module 14, an inspection module 16, a powder coat module 18, an oven module 20, and an unload module 22. A conveyor track 24 may be utilized to convey the article through manufacturing chain 10. It should be understood that while manufacturing chain 10 is illustrated as a powder coating system, manufacturing chain 10 may be any type of manufacturing system requiring one or more modular manufacturing units. For example, manufacturing chain 10 may embody an engine block assembly line, a brake assembly line, or any other manufacturing system known in the art. Furthermore, it is contemplated that although FIG. 1 discloses utilizing six modules, a fewer or greater number of modules may alternatively be used. Also, more than one module of a particular type may be employed within the same chain, if desired.

Modular manufacturing units may be specialized manufacturing stations containing all equipment necessary to accomplish a particular manufacturing task within a self-contained vessel. Modular manufacturing units may combine with other modular manufacturing units to perform more complicated manufacturing tasks. In addition, the self-contained characteristic of modular manufacturing units may allow them to be readily moved wherever they are needed. Furthermore, modular manufacturing units may be interchanged with other modular manufacturing units of a manufacturing chain.

Washer module 12 may remove foreign substances from the article before powdered paint is applied. Such foreign substances may include, for example, grease, dirt, dust, oils, or any other substance that may interfere with the paint application process. Washer module 12 may include a water tank 26 for supplying water or a solvent mixture to the module, a water pump 28 for circulating water or the solvent mixture through the module, a plurality of water nozzles 30 for spraying the article with water or the solvent mixture, a plurality of water barrier panels 32 for preventing the water or the solvent mixture from escaping the module, and a drain system (not shown) for returning the used water or the solvent mixture to water tank 26. It should be understood that washer module 12 may be connected to a utility infrastructure of a facility and receive water from that connection. In such a configuration, water tank 26 and water pump 28 may be unnecessary.

Blow off module 14 may remove any water or solvent mixture remaining on the article after the article passes through washer module 12. Blow off module 14 may include a fan 34 for pressurizing air, a plurality of air nozzles 36 for blowing air at the article, and a plurality of air barrier panels 38 to prevent the air blown from nozzles 36 from interfering with activities or equipment outside of blow off module 14.

Inspection module 16 may provide a location for an operator 40 to inspect the article. The inspection may involve visual, physical, or chemical analyses to determine the presence of any remaining impurities on the surface of the article.

Powder coat module 18 may apply a paint in powdered form to the article. Powder coat module 18 may include a paint applicator 42 for coating the article with the paint, and a plurality of paint barrier panels 44 for containing the paint within the confines of powder coat module 18.

Oven module 20 may heat the coating of freshly applied paint. By applying heat, the coat of paint may cure and set on the article making the application permanent. Oven module 20 may include one or more infrared heater 46, which may contain a plurality of infrared heater lamps 48 for generating the heat necessary for the coating of paint to cure on the article.

Unload module 22 may provide a location for an operator 50 to remove the article from manufacturing chain 10. After passing through manufacturing chain 10, it is contemplated that the article may be transported to another manufacturing chain (not shown) for further processing, if desired. Alternatively, the article may taken to a storage location (not shown) for storage until the article is needed, or to a transportation vehicle for delivery to a customer.

As illustrated in FIG. 1, conveyor track 24 may move an article from module to module during the manufacturing process. For example, conveyor track 24 may be an air balancer, a series of hoists, an electrified monorail, or any device capable of moving an article from module to module. In exemplary embodiment, conveyor track 24 may be a hollow, tubular beam running along a top center portion of manufacturing chain 10, with an opening 52 running along the length of a bottom side. A plurality of gripping devices 54 may extend through opening 52 and attach to a cable 56 running within the interior of conveyor track 24. Gripping devices 54 may grip the article to be conveyed through the manufacturing chain and may include, for example, a hook, a clamp, a latch or any other device capable of temporarily grasping the article. In addition, cable 56 may be associated with a drive system (not shown), which may move the gripping devices and associated articles through manufacturing chain 10. It is contemplated that cable 56 may be substituted with a chain, belt, or any other device that may convey gripping devices 54 through manufacturing chain 10. In an alternate embodiment, conveyor track 24 may be mounted on the floor and/or contain a transport device such as, for example, a conveyor belt to convey the article from module to module. In yet another embodiment, conveyor track 24 may be omitted, and the article may be transported between modules manually.

As illustrated in FIG. 1, each module of manufacturing chain 10 may include a frame 58. Frame 58 may provide structural support for each module and have universal features that can be utilized by all types of modules, as needed.

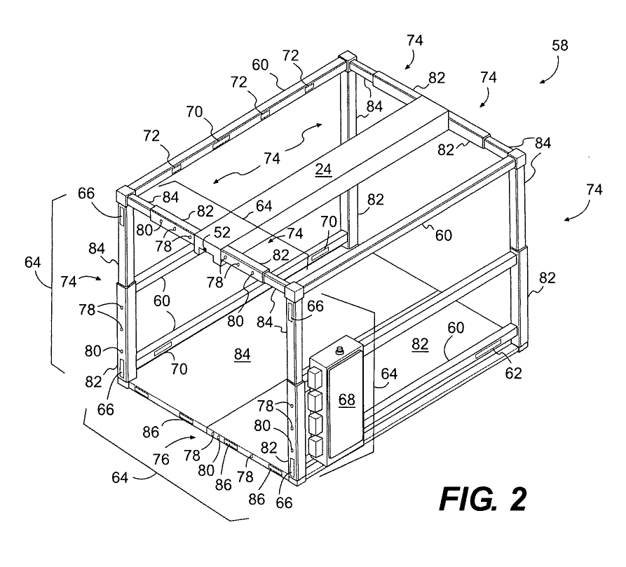

FIG. 2 provides a diagrammatic perspective of frame 58 according to an exemplary embodiment. Frame 58 may include a plurality of support beams 60 for supporting manufacturing equipment such as, for example, a washer or a paint applicator, a utility source 62 for providing utilities to the module, an expansion/contraction system 64 for expanding and contracting frame 58, a plurality of module connectors 66 for connecting frame 58 to the frames of other modules, and a control system 68 for operating frame 58 and the manufacturing equipment associated with the module.

Support beams 60 may form an exterior skeleton to which all other elements of the manufacturing module may be attached, and may be fabricated from steel, carbon composites, or any other material known in the art suitable for supporting the manufacturing module. Support beams 60 may include mounting devices 70 and utilities connections 72. Mounting devices 70 may be, for example, hooks, latches, sockets, or any other device capable of supporting manufacturing equipment to be mounted on support beams 60. Mounting devices 70 may interact with corresponding hooks, latches, and sockets located on the manufacturing equipment to support the equipment. In addition, utilities connections 72 may provide such utilities as, for example, electrical power, water, compressed air, gas, or any other utility needed for the operation of the manufacturing equipment. Utility connections 72 may embody electrical outlets, quick connect interfaces, or any other utility interface capable of engaging the manufacturing equipment.

Utility source 62 may supply the utilities to connections 72 via wires and/or tubes (not shown) running along an interior of support beams 60 and an exterior of frame 58. Utility source 62 may be disposed at any location convenient for receiving utilities from an outside source. Such outside sources may include, for example, a facility electrical power grid (not shown), a battery (not shown), a compressed air tank, and/or a water supply. It is contemplated that electrical power, compressed air, and/or water may be supplied to an initial module in a manufacturing chain, with the other modules receiving the utilities from the initial module, if desired.

Expansion/contraction system 64 may facilitate the expansion and contraction of frame 58 to accommodate the transportation and deployment of the manufacturing module. That is, expansion/contraction system 64 may adjust the size and shape of frame 58 in a vertical and/or horizontal direction. Expansion/contraction system 64 may include expansion/contraction beams 74, an expansion/contraction platform 76, holes 78, and fastening devices 80. Each expansion/contraction beam 74 and expansion/contraction platform 76 may be formed from steel, carbon composites, or any other material known in the art suitable for supporting the manufacturing module and may include a hollow tubular portion 82 and a piston portion 84. Piston portion 84 may be slidably received within tubular portion 82. Piston portion 84 may be manually moved and locked into place in relation to tubular portion 82 at specified lengths. Locking may be accomplished by locating holes 78 at specified locations along the exterior of tubular portion 82 and at an end of piston portion 84. That is, fastening devices 80 may be inserted into holes 78 when holes 78 on tubular portion 82 and piston portion 84 are aligned. Such fastening devices 80 may include bolts, screws, pins, spring actuated bearings located on piston portion 84, or any other device capable of locking piston portion 84 in place.

It is contemplated that in an alternate embodiment, tubular portions 82 and piston portions 84 of expansion/contraction beams 74 and expansion/contraction platform 76 may be physically separated in a stored/contracted configuration, if desired. Upon deployment/expansion of frame 58, tubular portions 82 and piston portions 84 may be secured together by clamps, bolts, pins, screws, spring actuated bearings, or any other device capable of securing tubular portion 82 and piston portion 84 together.

Expansion/contraction platform 76 may include engagement holes 86 for interaction with transportation vehicles such as forklifts. Engagement holes 86 may facilitate the relocation of the module to any location desired. In an alternate embodiment, expansion/contraction platform 76 may include castors, a sled, or any other device that may facilitate the relocation of frame 58 and the associated module.

Although support and expansion/contraction beams 60, 74 are illustrated as forming a cubic shape, support and expansion/contraction beams 60, 74 may be positioned to form any shape conducive to the production of a finished article. Additionally, the number of support and expansion/contraction beams 60, 74 utilized to form the exterior skeleton may vary depending upon the shape of the frame. Support and expansion/contraction beams 60, 74 may be secured together by mechanical fasteners, welds, or any other devices known in the art that are used to secure components.

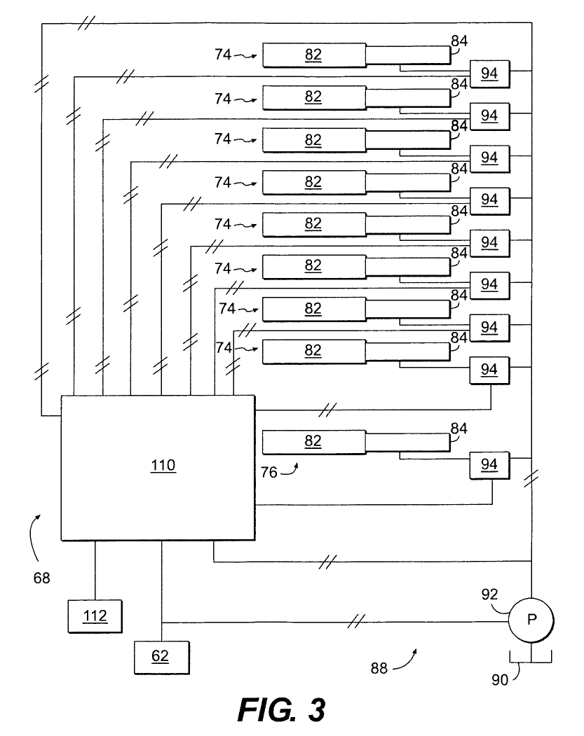

FIG. 3 illustrates an additional embodiment of expansion/contraction system 64 where holes 78 and fastening devices 80 are replaced with a hydraulic system 88. When hydraulic system 88 is used to actuate the expansion and contraction of frame 58, piston portion 84 may be arranged within tubular portion 82 to form two separate hydraulic chambers (not shown). It is contemplated that piston portion 84 and tubular portion 82 of expansion/contraction beams 74 having a vertical orientation with respect to the ground may form only one hydraulic chamber, if desired. The pressure chambers may be selectively supplied with and drained of a pressurized fluid from hydraulic system 88 to cause piston portion 84 to displace within tubular portion 82, thereby changing the effective length of expansion/contraction beams 74.

Hydraulic system 88 may include a plurality of fluid components that cooperate together to manipulate expansion/contraction beams 74. Specifically, hydraulic system 88 may include a tank 90 holding a supply of fluid and a source 92 configured to pressurize the fluid and to direct the pressurized fluid to one or more expansion/contraction beams 74. It is contemplated that hydraulic system 88 may include additional and/or different components such as, for example, accumulators, restrictive orifices, check valves, pressure relief valves, makeup valves, pressure-balancing passageways, and other components known in the art.

Tank 90 may constitute a reservoir configured to hold a supply of fluid. The fluid may include, for example, a dedicated hydraulic oil, or any other fluid known in the art. It is contemplated that hydraulic system 88 may be connected to multiple separate fluid tanks, if desired.

Source 92 may produce a flow of pressurized fluid and include a pump such as, for example, a variable displacement pump, a fixed displacement pump, a variable delivery pump, or any other source of pressurized fluid known in the art. Source 92 may be operationally connected to a power source (not shown) of the manufacturing module by, for example, an electrical circuit (not shown), or in any other suitable manner. It is contemplated that multiple sources of pressurized fluid may be interconnected to supply pressurized fluid to hydraulic system 88.

Each expansion/contraction beam 74 may include at least one control valve 94 that functions to meter pressurized fluid from source 92 to one of the first and second hydraulic chambers and to allow fluid from the other of the first and second chambers to drain to tank 90. Specifically, control valve 94 may include a spring biased valve mechanism that is solenoid actuated and configured to move between a first position at which fluid is allowed to flow into one of the first and second chambers and a second position at which fluid flow is drained from the other of the first and second chambers. The location of the valve mechanism between the first and second positions may determine a flow rate of the pressurized fluid directed into and out of the associated first and second chambers. The valve mechanism may be movable between the first and second positions in response to a demanded flow rate that produces a desired movement of frame 58. It is contemplated that control valve 96 may alternately be hydraulically actuated, mechanically actuated, pneumatically actuated, or actuated in any other suitable manner.

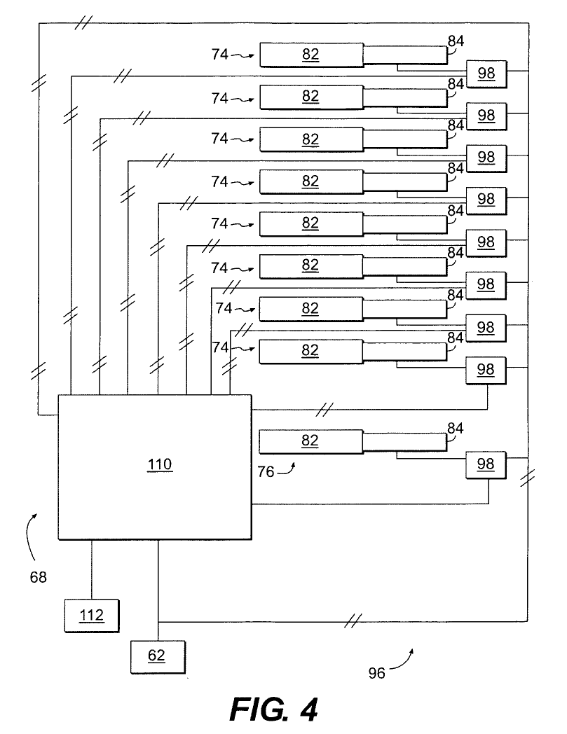

FIG. 4 illustrates yet another embodiment of expansion/contraction system 64, where holes 78 and fastening devices 80 are combined with an electric motor system 96. Electric motor system may include a plurality of electric motors 94 operationally connected to each expansion/contraction beam 74, with each motor 94 being configured to linearly expand and contract beams 74. Electric motors 98 may be AC induction motors, brushless DC motors, linear motors, or any other type of motor capable of linearly moving piston portion 84 in and out of tubular portion 82. Additionally, electric motors 98 may be directly powered by utility source 62 via electrical wires running along the interior of support beams 60 and along the exterior of expansion/contraction beams 74.

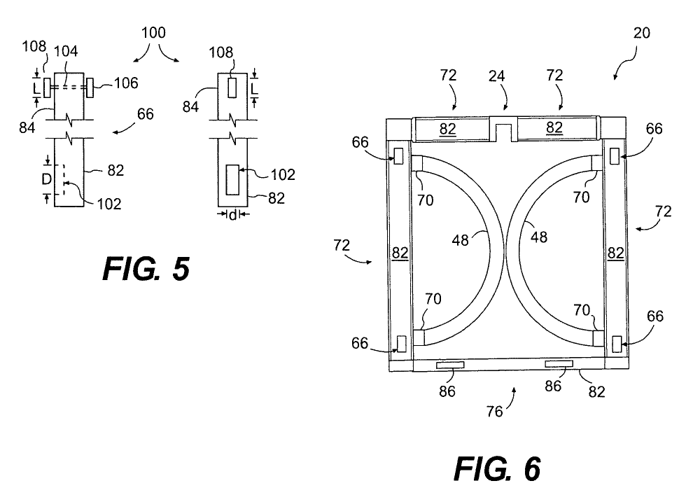

FIG. 5 illustrates module connecting system 66, which may be located at each end of expansion/contraction beams 74 having a vertical orientation in relation to the ground. Module connecting system 66 may be used to secure frame 58 of one module to frames 58 of other manufacturing modules. Module connecting system 66 may include a rotatable engaging element 100 located at a top end of expansion/contraction beams 74. Rotatable engaging element 100 may have a vertical orientation in relation to the ground. Module connecting system 66 may also include a receiving element 102 located at a bottom end of expansion/contraction beams 74 having a vertical orientation in relation to the ground. Engaging element 100 may have a horizontal portion 104, which may extend horizontally through piston portion 84 of expansion/contraction beam 74 and terminate at a handle portion 106, and a locking portion 108. Receiving element 102 may be an opening located in tubular portion 82 of expansion/contraction beam 74. Receiving element 102 may be sized so that a vertical dimension D is slightly larger than a length L of locking portion 108, and a horizontal dimension d is smaller than the length L. For embodiments utilizing hydraulic system 88, receiving element 102 may be located so as to avoid the hydraulic chamber created inside tubular portion 82. Locking portion 108 of another module may be inserted into receiving element 102 when locking portion 108 is vertically aligned with the ground. Once locking portion 108 is inserted, engaging element 100 may be rotated so that locking portion 108 cannot not be removed from receiving element 102. It is contemplated that other engaging devices may be used to connect modules in a manufacturing chain such as, for example, cotter pins, magnets, or any other device capable of interlocking modules of a manufacturing chain, if desired. It is further contemplated that module connection system 68 may be omitted from frame 58. In such a configuration, modules of the manufacturing chain may be aligned but not interconnected.

Referring back to FIG. 4, control system 68 may include a controller 110, which may be embodied in a single microprocessor or multiple microprocessors that include a means for controlling the operation of various systems of the manufacturing module 12-22 and frame 58. Numerous commercially available microprocessors can be configured to perform the functions of controller 110. Controller 110 may include a memory, a secondary storage device, a processor, and any other components for running an application. Various other circuits may be associated with controller 110 such as utility supply circuitry, signal conditioning circuitry, and any other types of circuitry needed for the operation of the manufacturing module. It is contemplated that all control systems 68 of a manufacturing chain 10 may be interconnected through a local area network or wirelessly with one control system 68 selected as a master controller to coordinate the processes of the manufacturing chain, if desired.

Control system 68 may receive input from an operator interface 112 and to control the operation of the various systems of the manufacturing module and frame 58 in response to the input. Operator interface 1 12 may receive input from an operator indicative of a desired manufacturing operation. It is contemplated that the input could alternately be a computer generated command from an automated system that assists the operator, or an autonomous system that operates in place of the operator. Specifically, operator interface 112 may be a touch screen, keyboard, control panel, or any other device capable of facilitating communication between the operator and control system 68.

FIG. 6 discloses an exemplary embodiment of electric infrared oven module 20, with frame 58 in a contracted position. In the contracted position, manufacturing equipment utilized in the manufacturing process can be stored within frame 58. A portion of mounting devices 70 on support beams 60 may be specifically located to engage the manufacturing equipment in a storage position so that the manufacturing equipment may be secured to frame 58. The equipment storage configuration may be more compact than the equipment deployment configuration utilized when frame 58 is in the expansion position, and the equipment is operating. Alternately, the manufacturing equipment may be secured to frame 58 in the stored position via ropes, chains, belts, or any other securing device capable of securing the manufacturing equipment.

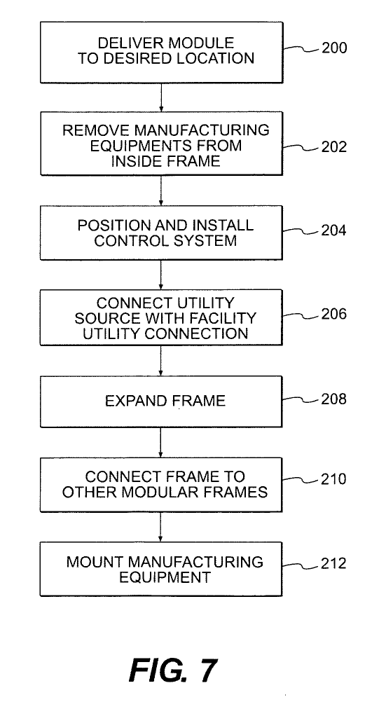

FIG. 7 discloses a flowchart illustrating an exemplary method of expanding frame 58. Additionally, FIG. 7 discloses installing module 12-22 in manufacturing chain 10. Furthermore, FIG. 7 discloses deploying and installing the manufacturing equipment on frame 58.

### INDUSTRIAL APPLICABILITY

The disclosed manufacturing system may provide portability and flexibility to a manufacturing process, by utilizing a frame capable of expansion and contraction. In addition, because of its ability to contract its size, the manufacturing system may be transported from one location to another with various transportation vehicles such as, for example, trucks, trains, airplanes, or any other device capable of transporting objects. In addition, by utilizing a modular strategy, the manufacturing system may be easily and quickly modified to address changes in consumer demand. The method for storage and deployment of a manufacturing module 12-22 will now be explained.

FIG. 7 illustrates a flow diagram depicting an exemplary method of deploying a manufacturing module 12-22. The method may begin when module 12-22 is removed from a shipping device such as, for example, a truck, and delivered to a desired manufacturing location (step 200). Once the module is positioned, the manufacturing equipment stored within frame 58 may be removed (step 202).

After the stored manufacturing equipment is removed, control system 68 may be positioned and installed on frame 58 via mounting device 70 and utilities connection 72 (step 204). In addition, control system 68 may be communicatively connected to control systems 68 mounted on other manufacturing modules in the manufacturing chain via a local area network interface or wirelessly.

Upon control system 68 being installed, utility source 62 may be connected with existing utility connections from the facility where the manufacturing module is being deployed (step 206). Alternatively, utility source 62 may be connected with utilities connection 72 of another frame 58 in manufacturing chain 10. Once the utility connection is made, electric, hydraulic, pneumatic, and other forms of power may be provided to control system 68 and all other systems located on frame 58.

After frame 58 receives power from utility source 62, frame 58 may be expanded into an operational position (step 208). This expansion may be accomplished manually or automatically by control system 68 via operator interface 112. Control system 68 may be programmed with desired expansion dimensions of frame 58 for the particular manufacturing module being utilized. For example, the expansion dimensions of module 12 may be 16 feet by 16 feet by 20 feet.

Once frame 58 is expanded into the operational position, manufacturing module 12-22 may be connected to other previously installed modules via module connection systems 66 (step 210). Engaging elements 100 of both manufacturing modules to be connected may be inserted into receiving elements 102 of each manufacturing module. In particular, locking portions 108, while being vertically situated in relation to the ground and aligned with the geometry of receiving element 102 may be inserted into receiving elements 102. Once locking portions 108 are inserted into receiving elements 102, handle portions 106 may be rotated. As handle portions 106 are rotated, attached horizontal portions 104 may cause locking portions 108 to rotate in a similar fashion as handle portions 106. When locking portions 108 are rotated so that they are horizontally situated in relation to the ground, locking portions 108 may be no longer aligned with the geometry of receiving element 102 and may be trapped inside receiving element 102. Such entrapment may lock engagement elements 100 with receiving elements 102.

Manufacturing equipment such as, for example, infrared heater lamps 48 may be mounted on frame 58 via mounting devices 70 (step 212). After being mounted, the manufacturing equipment may be connected to the facility utilities and/or utilities of other manufacturing modules in manufacturing chain 10 via utility connections 72 (step 214). The manufacturing module 12-22 may then be ready for operation.

The disengaging of module 12-22 from manufacturing chain 10 and the collapsing of frame 58 may be accomplished by performing steps 200-214 in the reverse order. The process may begin with the removal of the manufacturing equipment from frame 58 and end with the reattachment of the manufacturing equipment to frame 58 when frame 58 is in a contracted state.

Because of the compactness of the manufacturing module, when it is in a storage configuration, it can be transported by a wide variety of transportation vehicles such as, for example, fork lifts, shipping containers, trucks, air planes, or any other transportation vehicle. Due to the flexibility of transportation means, the manufacturing module can be moved to another location within a manufacturing facility, to another manufacturing facility, or to a customer's job site. The variety of possible deployment locations for the manufacturing module need not be limited by the needs of one type of transportation system. For example, the location of deployment of the manufacturing module need not be limited to a site that is adjacent to a road because of the limitations of being transported by a truck.

Additionally, the size and geometry of the manufacturing chain assembled from multiple manufacturing modules may not be limited by the size and geometry of transportation vehicles. Each module of the manufacturing chain may be moved by different transportation vehicles allowing a wide variety of possible sizes and configurations not limited by the size of a single transportation device. The wide variety of possible sizes and configurations may include, for example, “L” shaped or “U” shaped configurations. In addition, modules may be added to or removed from the manufacturing chain as needed. Such flexibility may increase the variety of possible finished products that may produced and manufacturing processes that may be performed.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

1. A modular manufacturing station, comprising:
a plurality of beams forming a skeleton and being capable of extension and retraction;
at least one utility connection for receiving external utilities;
at least one piece of manufacturing equipment; and
a control system configured to regulate operation of the manufacturing equipment.

2. The modular manufacturing station of claim 1, further including an article transportation device for transporting an article through the manufacturing station.

3. The modular manufacturing station of claim 1, further including at least one connection device for connecting to another modular manufacturing station.

4. The modular manufacturing station of claim 3, wherein the control system is further configured to communicate with other modular manufacturing stations.

5. The modular manufacturing station of claim 1, wherein the control system is further configured to automatically expand and contract the plurality of beams.

6. The modular manufacturing station of claim 1, wherein the control system is further configured to expand and contract the plurality of beams based on input from an operator.

7. The modular manufacturing station of claim 1, further including one of a hydraulic system and electric motor system utilized to expand the plurality of beams.

8. A method for deploying a manufacturing station, comprising:
connecting to a utilities source;
expanding the manufacturing station to a desired dimension; and
setting the manufacturing station to an operational state in which the manufacturing station performs a manufacturing task.

9. The method of claim 8, further including connecting to other manufacturing stations.

10. The method of claim 9, further including regulating the manufacturing tasks of the other manufacturing stations.

11. The method of claim 8, wherein expanding the manufacturing station further includes actuating a hydraulic system.

12. The method of claim 8, wherein expanding the manufacturing station further includes actuating an electric motor system.

13. The method of claim 8, wherein expanding the manufacturing station is performed automatically.

14. The method of claim 8, wherein expanding the manufacturing station is performed based on user input.

15. A manufacturing chain comprising:
a first modular manufacturing station including:
a plurality of beams forming a skeleton and being capable of extension and retraction;
at least one utility connection for receiving external utilities;
at least one connection device for connecting to another modular manufacturing station;
at least one piece of manufacturing equipment; and
a control system configured to regulate operation of the manufacturing equipment wherein, the first modular manufacturing station is a master modular manufacturing station having operational control over the at least a second modular manufacturing station, the at least second manufacturing station including:
a plurality of beams forming a skeleton and being capable of extension and retraction;
at least one connection device for connecting to another modular manufacturing station;
at least one pin of manufacturing equipment; and
a control system configured to regulate operation of the manufacturing equipment.

16. The manufacturing chain of claim 15, further including an article transportation device for transporting an article through the manufacturing chain.

17. The manufacturing chain of claim 15, wherein each modular manufacturing station is further configured to automatically expand and contract the plurality of beams.

18. The manufacturing chain of claim 15, wherein each modular manufacturing chain is further configured to expand and contract the plurality of beams based on input from an operator.

19. The manufacturing chain of claim 15, further including a hydraulic system utilized to expand the plurality of beams.

20. The manufacturing chain of claim 15, further including an electric motor system utilized to expand the plurality of beams.

21. A modular manufacturing station, comprising:
a plurality of beams forming a skeleton;
an article transportation device for transporting at least one article through the manufacturing station, the article transportation device being configured to operably connect to other article transportation devices associated with other modular manufacturing stations;
at least one utility interface device for receiving external utilities;
at least one piece of manufacturing equipment; and
a control system configured to regulate operation of the manufacturing equipment and the transportation device.

22. The modular manufacturing station of claim 21, wherein the article transportation device includes a hollow portion through which a conveying device travels.

23. The modular manufacturing station of claim 22, wherein the article transportation device further includes at least one article gripping device operably connected to the conveying device.

24. The modular manufacturing station of claim 23, wherein the article transportation device is operably connected to the other article transportation devices via the conveying device.

25. The modular manufacturing station of claim 24, wherein the article transportation device shares the conveying device with the other article transportation devices.

26. The modular manufacturing station of claim 25, wherein the conveying device is one of a cable, chain, and belt.

27. The modular manufacturing station of claim 21, wherein the article transportation device is positioned along a top portion of the modular manufacturing station.

28. The modular manufacturing station of claim 21, wherein the article transportation device is positioned along a bottom portion of the modular manufacturing station.

29. A manufacturing chain comprising:
a first modular manufacturing station including:
a plurality of beams forming a skeleton;
an article transportation device for transporting at least one article through the manufacturing station, the article transportation device being configured to operably connect to other article transportation devices associated with other modular manufacturing stations;
at least one utility connection for receiving external utilities;
at least one interface device for connecting to another modular manufacturing station;
at least one piece of manufacturing equipment; and
a control system configured to regulate operation of the manufacturing equipment wherein, the first modular manufacturing station is a master modular manufacturing station having operational control over the at least a second modular manufacturing station, the at least second manufacturing station including:
a plurality of beams forming a skeleton;
an article transportation device for transporting at least one article through the manufacturing station, the article transportation device being configured to operably connect to other article transportation devices associated with other modular manufacturing stations;
at least one interface device for connecting to another modular manufacturing station;
at least one piece of manufacturing equipment; and
a control system configured to regulate operation of the manufacturing equipment according to instruction from the master control system.

30. The manufacturing chain of claim 29, wherein each article transportation device includes a hollow portion through which a conveying device travels.

31. The manufacturing chain of claim 30, wherein each article transportation device further includes at least one article gripping device operably connected to the conveying device.

32. The manufacturing chain of claim 31, wherein each article transportation device is operably connected to another article transportation device via the conveying device to form a continuous article transportation device along the entire manufacturing chain.

33. The manufacturing chain of claim 32, wherein the manufacturing chain includes one continuous conveying device configured to travel through the hollow portion of each article transportation device of the manufacturing chain.

34. The manufacturing chain of claim 33, wherein the conveying device is one of a cable, chain, and belt.

35. The manufacturing chain of claim 29, wherein each article transportation device is positioned along a top portion of an associated modular manufacturing station.

36. The manufacturing chain of claim 29, wherein each article transportation device is positioned along a bottom portion of an associated modular manufacturing station.
